(19) United States
(12) Patent Application Publication
(10) Pub. No.: US 2022/0050673 A1
(43) Pub. Date: Feb. 17, 2022

(54) MANAGEMENT SYSTEM AND CONTROL METHOD THEREOF

(71) Applicant: CANON KABUSHIKI KAISHA, Tokyo (JP)

(72) Inventor: Toshiyuki Nakazawa, Tokyo (JP)

(21) Appl. No.: 17/388,074

(22) Filed: Jul. 29, 2021

(30) Foreign Application Priority Data
Aug. 12, 2020 (JP) 2020-136379

(51) Int. Cl. G06F 8/65; G06F 8/71

(52) U.S. Cl. CPC G06F 8/65; G06F 8/71

(57) ABSTRACT

A system comprising: a manager apparatus that manages a device; and an information processing apparatus that functions as an agent that performs communication via a network with the device based on an instruction of the manager apparatus, wherein the manager apparatus transmits an instruction of a device operation to the agent, wherein the information processing apparatus, as a function of the agent, when an update of software of a device has been instructed as a device operation from the manager apparatus, transmits to that device an update request, which includes URL information that indicates a reverse proxy which operates in the information processing apparatus, and wherein by the device performing transmission of data in response to the update request to the URL information that indicates the reverse proxy, that data is transferred to the manager apparatus via the information processing apparatus.

### BACKGROUND OF THE INVENTION

### Field of the Invention

The present invention relates to a management system and a control method thereof.

### Description of the Related Art

Conventionally, a management system for managing a plurality of image forming apparatuses (hereinafter, referred to as devices) connected via a network has been known. The management system, for example, obtains information from devices using communication by various protocols or instructs the devices to execute processing. In a case of installing an application on a device or updating firmware of a device, instead of transmitting the application or firmware to the device, there are cases where an address for obtaining the application or firmware is instructed to the device. In such cases, the device obtains content from the designated address.

Also, a method of Japanese Patent Laid-Open No. 2009-140115, for example, is cited as a technique for preventing access to a WEB server from a plurality of clients from being concentrated. Japanese Patent Laid-Open No. 2009-140115 discloses that a relay server instructs a content cache server to cache content and replace, for a client, location information of content on a WEB server with location information on the cache server.

In a case where there are many devices to be managed, there are cases where a management system is configured by one management server (manager) for performing overall management and a plurality of agents for executing processing related to a device in accordance with an instruction of the management server. In a case where application or firmware obtainment processing is performed in such a configuration, the management server needs to directly communicate with the device and decide an update file that is necessary for the device; however, from the viewpoint of security, it is desirable to limit direct communication between the manager and the device.

However, there is a problem in that in the relay server described in Japanese Patent Laid-Open No. 2009-140115, it is difficult to limit direct communication between the manager that manages software and the device.

The present invention is made in view of the foregoing problem, and provides a technique for limiting direct communication between a manager that manages software and a device.

### SUMMARY OF THE INVENTION

According to one aspect of the present invention, there is provided a management system comprising: a manager apparatus configured to manage a device; and an information processing apparatus configured to function as an agent that performs communication via a network with the device based on an instruction of the manager apparatus, wherein the manager apparatus transmits an instruction of a device operation to the agent, wherein the information processing apparatus, as a function of the agent, in a case where an update of software of a device has been instructed as a device operation from the manager apparatus, transmits to that device an update request, which includes URL information that indicates a reverse proxy which operates in the information processing apparatus, and wherein by the device performing transmission of data in response to the update request to the URL information that indicates the reverse proxy, that data is transferred to the manager apparatus via the information processing apparatus.

Further features of the present invention will become apparent from the following description of exemplary embodiments (with reference to the attached drawings).

### BRIEF DESCRIPTION OF THE DRAWINGS

FIG. 1 is a view illustrating an example of an overall configuration of a system according to an embodiment of the present invention.

FIG. 2 is a view illustrating an example of a hardware configuration of an information processing apparatus according to the present invention.

FIG. 3A is a view illustrating an example of a software configuration of a manager according to the present invention.

FIG. 3B is a view illustrating an example of a software configuration of an agent according to the present invention.

FIG. 4 is a flowchart of data obtainment processing according to the present invention.

FIG. 5A is a sequence diagram of installation processing of an application according to the present invention.

FIG. 5B is a sequence diagram of installation processing of an application (cached) according to the present invention.

FIG. 6 is a sequence diagram illustrating a flow of firmware update processing according to the present invention.

FIG. 7 is a flowchart illustrating a flow of processing that a manager implements in firmware update processing according to the present invention.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

[System Configuration]

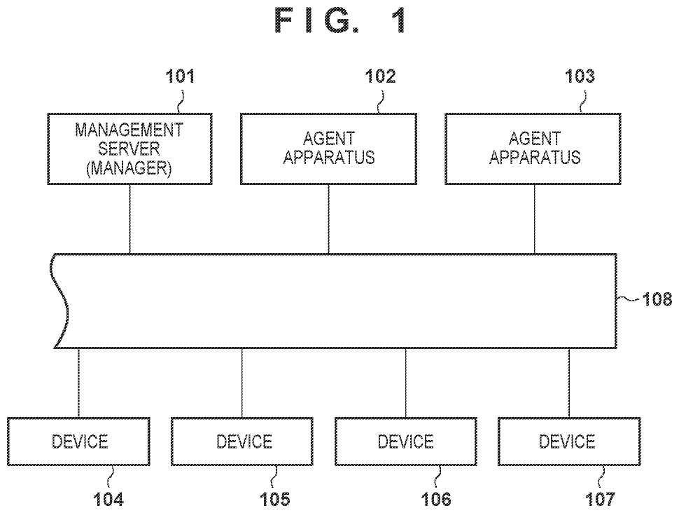

FIG. 1 is a view illustrating an example of a configuration of the entire network system in which a manager/agent system are included according to the present embodiment. The network system functions as a management system for devices configured to include one management server (hereinafter, referred to as a “manager”) 101 and a plurality of agent apparatuses (hereinafter, referred to as “agents”) 102 and 103. The manager 101 manages network devices (hereinafter, referred to as “devices”) 104 to 107. The manager 101, the agents 102 and 103, and the devices 104 to 107 are connected to be able to communicate with each other by a network 108.

The manager 101 is an apparatus realized by installing a device management application in an information processing apparatus. An agent is an apparatus that is realized by installing a device agent application on an information processing apparatus. By installing both a device management application and a device agent application on one information processing apparatus, an agent function can be realized in the apparatus in addition to a manager function. In such a case, the manager manages a plurality of devices via an agent in the apparatus itself and one or more agents that are realized in another apparatus on the network.

In the following, description is given assuming that the agent 102 sets the devices 104 and 105 as monitoring targets and that the agent 103 sets the devices 106 and 107 as monitoring targets. A detailed description will be given below using the agent 102 as a representative of the agents and the device 104 as a representative of the devices. Note that other agents and devices are assumed to perform equivalent operations.

The manager 101 instructs the agent 102 to perform operation related to the device 104. The agent 102 performs processing such as transmission of a request to the device 104 in accordance with an instruction from the manager 101 and transmits a processing result thereof to the manager 101. An example of processing by the agent 102 includes obtainment of device information and operation information from the device 104. Other examples include a change in setting values for the device 104, an instruction to install an application on the device 104, and the like.

In FIG. 1, a configuration in which there are two agents and four devices to be managed is illustrated; however, these numbers are an example and may be increased or decreased. Thus, even in a case where tens of thousands of devices are managed via several tens of agents, the configuration and operations are the same as those described below.

Also, the configuration of the network 108 that connects each device to be capable of communication is not particularly limited. Note that the network 108 may include a combination of the Internet, a Local Area Network (LAN), a Wide Area Network (WAN), and the like, that any communication standard may be used, and that the network may be wired or wireless.

[Hardware Configuration]

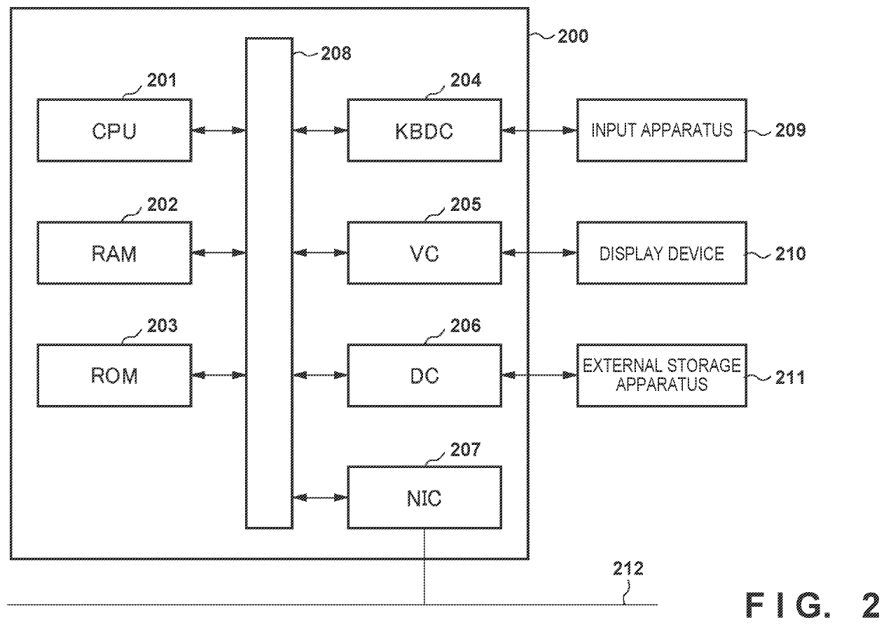

FIG. 2 is a view illustrating an example of a hardware configuration of an information processing apparatus capable of operating as the manager 101 or the agent 102 or 103 according to the present embodiment. An information processing apparatus 200 is configured to include a CPU 201, a RAM 202, a ROM 203, a KBDC 204, a VC 205, a DC 206, and an NIC 207. The CPU 201 collectively controls each unit connected via a system bus 208. The CPU 201 realizes various functions by loading to the RAM 202 as necessary software (programs) stored in the ROM 203 or an external storage apparatus 211 or downloaded via a network 212 and then executing it.

The RAM 202 is a volatile storage region and functions as the main memory, a work area, and the like of the CPU 201. The external storage apparatus 211 is configured by a hard disk (HD), a solid state drive (SSD), or the like. The external storage apparatus 211 stores various applications including a boot program, an operating system (OS), an authentication server, an authentication client, and the like, as well as database data, user files, and the like. As described above, in the present embodiment, the CPU 201 of the information processing apparatus 200 operating as the manager 101 executes a device management application program. In addition, the CPU 201 of the information processing apparatus 200 operating as the agent 102 or 103 executes an agent application program.

The KBDC 204 is a keyboard controller and sends, to the CPU 201, input information from an input apparatus 209 such as a keyboard or a pointing device. The VC 205 is a video controller and controls display of a display device 210 configured by an LCD or the like. The DC 206 is a disk controller and controls accesses to and from the external storage apparatus 211. The NIC 207 is a communication controller and is connected to the network 212 to control communication with external apparatuses. Note that the configuration of the information processing apparatus illustrated in FIG. 2 is an example and that the information processing apparatus in which the manager 101 operates and the information processing apparatus in which the agent 102 operates may have different configurations.

[Software Configuration]

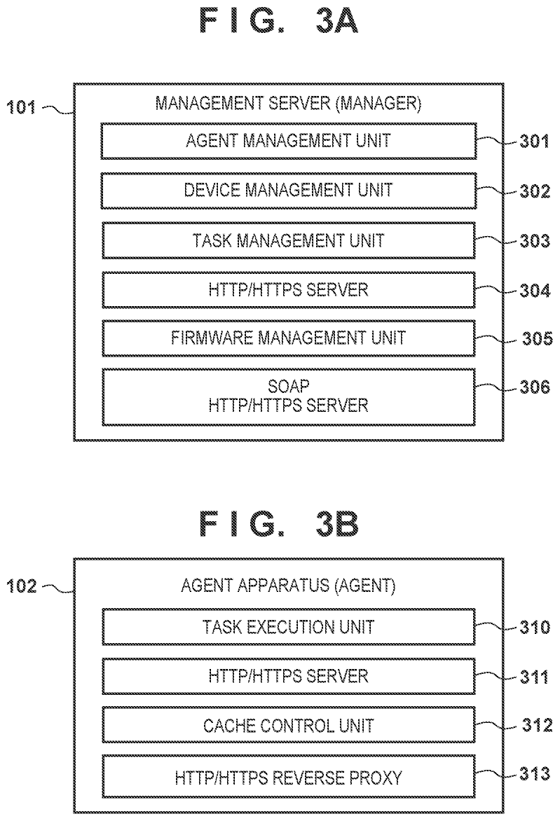

FIG. 3A is a view illustrating an example of a software configuration of the manager 101 according to the present embodiment. In the present embodiment, the information processing apparatus 200 operating as the manager 101 realizes the functions of each unit by reading and executing the program of the device management application. An agent management unit 301 manages information related to the agents 102 and 103. A device management unit 302 manages information related to the devices 104 to 107 to be managed. Information related to the devices includes information regarding a correspondence relationship between the device and the agent. A task management unit 303 manages the content and results of processing related to the devices, and instructs each agent to execute processing in relation to each device. The management information is stored in a database (not illustrated). Additionally, the manager 101 is assumed to hold, in the external storage apparatus 211, the program data of an application that can be provided to each device and manage location information thereof (storage destination) and the like. An HTTP/HTTPS server 304 uses HTTP or HTTPS communication to receive a request from the agent or the device or provide a WEB UI for the user to operate the manager 101.

A firmware management unit 305 performs management of firmware of devices. Note that the size of firmware of devices has increased and if the entirety of the firmware is forwarded when updating the firmware of devices, it would require a lot of time and bandwidth. In order to avoid this, configuration is taken so as to connect to a server for firmware update and instruct a device to obtain a differential file of a difference from the current firmware of the device.

A SOAP HTTP/HTTPS server 306 receives a SOAP message of a firmware update request, retrieves a function in the firmware management unit 305, and returns a result thereof to a request transmission source. Note that the HTTP/HTTPS server 304 and the SOAP HTTP/HTTPS server 306 are configured as separate elements here; however, a single HTTP/HTTPS server may provide these functions.

In the firmware management unit 305 firmware of various devices are stored. The device 104 invokes a function of the firmware management unit 305 via the HTTP/HTTPS server 304 together with product information of the device itself and version information of firmware as device information. The firmware management unit 305 returns address information (URL information) for obtaining data that is necessary for updating firmware of the device 104 from the product information and the version information in the request. The device 104, by transmitting an HTTP/HTTPS request that includes the product information of the device itself and version information of firmware to that address, receives data necessary for a firmware update and then performs a firmware update of the device itself.

FIG. 3B is a view illustrating an example of a software configuration of the agent 102 according to the present embodiment. In this embodiment, the information processing apparatus 200 operating as the agent 102 realizes the functions of each unit by reading and executing the program of the device agent application. A task execution unit 310 executes processing on the device 104 in accordance with an instruction from the manager 101, and then transmits the processing result to the manager 101. An HTTP/HTTPS server 311 uses HTTP and HTTPS communication to receive requests from the manager 101 and the device 104. A cache control unit 312 provides a cache function for content in the manager 101.

An HTTP/HTTPS reverse proxy 313 transmits the received HTTP request to the SOAP HTTP/HTTPS server 306 in the manager 101 and returns a response from the SOAP HTTP/HTTPS server 306 to a transmission source of the HTTP request. Here, the HTTP request is POST and an HTTP body is a SOAP XML message.

[Data Obtainment Processing]

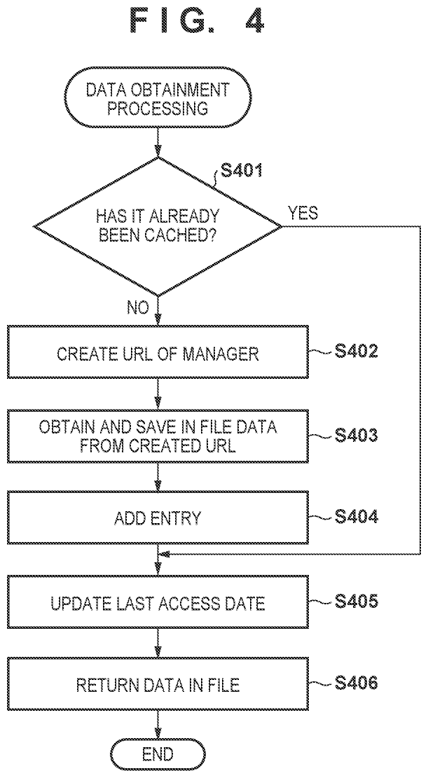

FIG. 4 is a flowchart illustrating a flow of data obtainment processing by the cache control unit 312 that the agent 102 illustrated in FIG. 3B comprises. When the HTTP/HTTPS server 311 receives a GET request with a path starting with a specific character string (e.g., “/cache/”), the data obtainment processing is invoked using the path as an argument. An example of the path is illustrated below.

/cache/applications/ocr.jar

/cache/firmware/4cb89c08-76a4-4caa-8c9d-2aa1021faac5

Also, in the present embodiment, the agent 102 manages data by a table structure illustrated in the following Table 1.

TABLE 1

| | | Last Access | |
|---|---|---|---|
| | | Date and | |
| Path | File Name | Time | Content Type |
| /cache/applications/ | b60514a3- | 2019 May 23 | application/ |
| ocr.jar | b98b | 10:28:34 | octet-string |
| /cache/applications/ | 9a6e6e2f- | 2019 May 23 | application/ |
| sso.jar | 1d6a | 10:32:42 | octet-string |

In the table illustrated in Table 1, a path indicates a path passed by an argument (i.e., a path designated by a GET request that the HTTP/HTTPS server 311 received). The file name indicates the file name of a file when data indicated by the path is obtained and saved in the agent 102. The last access date and time indicates the date and time at which the data obtainment processing is invoked using the path as an argument. The content type is a character string indicating the type of data.

In step S401, the cache control unit 312 confirms whether or not data indicated by a path passed by an argument has already been cached. Here, the table illustrated in Table 1 is referenced, and in a case where there is a path passed by an argument, it is determined that data has already been cached and in a case where there is no path, it is determined that data has not been cached. In a case where the requested data has already been cached (YES in step S401), the processing advances to step S405, and in a case where the requested data has not been cached (NO in step S401), the processing advances to step S402.

In step S402, the cache control unit 312 creates a URL (Uniform Resource Locator) of the manager 101 that corresponds to the requested path. For example, in a case where the requested path is “/cache/applications/sso.jar”, the path to be created will be “/public/applications/sso.jar”. In this way, a portion of the requested path character string (cache) is replaced with another character string (public).

In step S403, the cache control unit 312 transmits to the HTTP/HTTPS server 304 of the manager 101 an HTTP or HTTPS GET request in relation to the URL created in step S402 via the HTTP/HTTPS server 311. The cache control unit 312 saves, in the file, data included in a response to the request.

In step S404, the cache control unit 312 adds to the table illustrated in Table 1 an entry related to the data obtained from the manager 101. In the addition in this case, a content type is set to be the content type indicated in the HTTP header in the response from the HTTP/HTTPS server 304 in the manager 101.

In step S405, the cache control unit 312 updates the value of the last access date and time in the table illustrated in Table 1 to the current date and time.

In step S406, the cache control unit 312 returns to the HTTP/HTTPS server 311 the data of the file indicated by the file name and content type in the table illustrated in Table 1. At this time, the HTTP/HTTPS server 311 sets the value of the content type in the HTTP header of the response to the device and also sets the corresponding data in the body of the response. Then, the HTTP/HTTPS server 311 returns the response to the caller (device) of the GET request.

[Processing Sequence]

### (Before Caching)

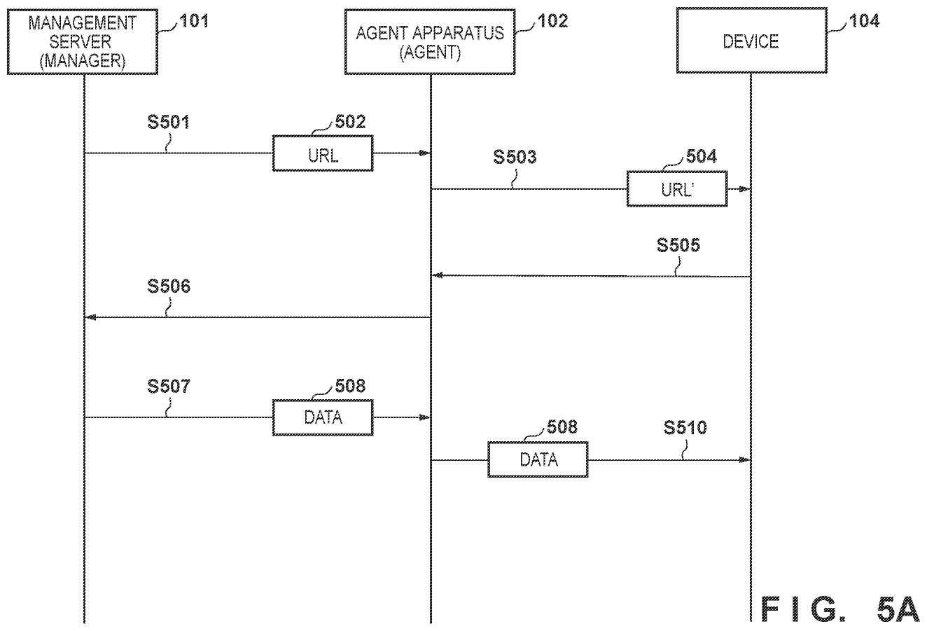

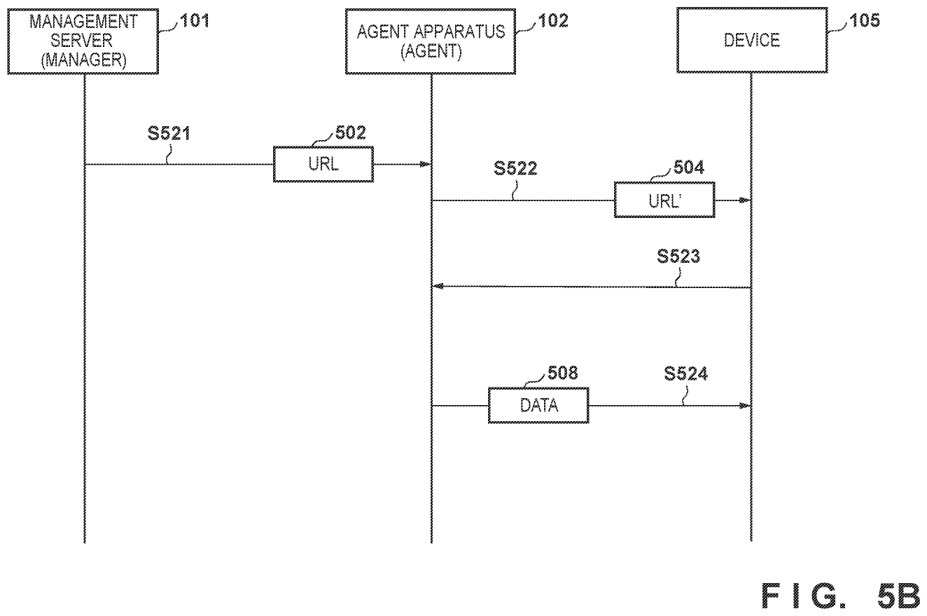

FIG. 5A is a sequence diagram illustrating a flow of processing for when the manager 101 instructs the device 104 associated with the agent 102 to install an application. It is assumed that, at the start of the present processing sequence, the agent 102 has not cached the data of the application to be installed. Also, assume that the IP addresses of the manager 101 and the agent 102 are “192.168.10.100” and “192.168.10.200”, respectively.

First, the manager 101 transmits to the HTTP/HTTPS server 311 of the agent 102 a request that includes an instruction to install an application to the device 104 (step S501). In the instruction here, a URL 502 (e.g., “http://192.168.10.100/public/applications/ocr.jar”) for the device 104 to obtain an application is included. The URL in this case indicates the storage destination of program data of the application managed by the manager 101.

The HTTP/HTTPS server 311 of the agent 102, when it receives a request from the manager 101, calls the task execution unit 310 in order to execute the requested instruction. The task execution unit 310 replaces the URL 502 included in the above request with a URL 504 for cache of the agent 102 (e.g., “http://192.168.10.200/cache/applications/ocr.jar”). Here, in a case where the manager 101 and the agent 102 are operating in the same information processing apparatus, the above-described replacement is not performed. The case of operating in the same information processing apparatus corresponds to, in other words, a case where a host address portion of the URL 502 (corresponding to the IP address portion of the URL described above) is the same as the address of the host on which the agent 102 operates.

Next, the task execution unit 310 transmits a request to the device 104 (step S503). The request in this case includes an instruction for the device 104 to use the replaced URL 504 to obtain and install the application.

The device 104 that received the request from the agent 102 transmits to the agent 102 an obtainment request for obtaining an application in relation to the URL 504 included in the request (step S505).

The HTTP/HTTPS server 311 of the agent 102, when it receives the obtainment request from the device 104, invokes the data obtainment processing described in FIG. 4. At this point, the agent 102 has not cached the data indicated at the URL 504; accordingly, the agent 102 transmits a request for obtainment of the application to the URL of the manager 101 in accordance with the processing illustrated in FIG. 4 (step S506). Here, the URL generated in step S402 of FIG. 4 is the same as the URL 502.

The HTTP/HTTPS server 304 of the manager 101 returns to the agent 102 data 508 requested by the URL (step S507).

The cache control unit 312 of the agent 102 caches the data 508 obtained from the manager 101 in accordance with the processing described in FIG. 4. Furthermore, the HTTP/HTTPS server 311 of the agent 102 performs distribution of software by returning the cached data 508 to the device 104 (step S510). Then, the device 104 installs the application using the data 508 received from the agent 102. Then, the present processing sequence is ended. Note that, in a case where the manager 101 and the agent 102 operate on the same information processing apparatus, the caching operation for the software may be omitted in the agent 102. For example, before the start of the processing of FIG. 4, the information processing apparatus in which each of the manager 101 and the agent 102 operates may be identified, and in accordance with the identification result, the content of the processing of FIG. 4 may be modified. Specifically, instead of the processing in FIG. 4, the agent 102 may execute processing of transferring, to the device 104, the data of the software obtained from the manager 101 as is.

### (After Caching)

FIG. 5B is a sequence diagram illustrating a flow of processing after the processing illustrated in FIG. 5A for when the manager 101 instructs the device 105 associated with the agent 102 to install the same application. At the start of the present processing sequence, it is assumed that the agent 102 has cached the data of the application as a result of the processing illustrated in FIG. 5A.

The processing in steps S521 to S523 is the same in steps S501 to S505 of FIG. 5A; accordingly, description will be omitted. The URL specified in the request transmitted from the device 105 in step S523 of FIG. 5B is the same as the URL (URL 504) in the request in step S505 of FIG. 5A. The HTTP/HTTPS server 311 of the agent 102 that received this request invokes the data obtainment processing described in FIG. 4. Here, the data 508 corresponding to the URL 504 has already been cached in the agent 102 by the processing in steps S506 to S507 of FIG. 5A.

The cache control unit 312 of the agent 102 returns the cached data 508 to the device 105 by the HTTP/HTTPS server 311 (step S524). Then, the device 105 installs the application using the data 508 received from the agent 102. Then, the present processing sequence is ended.

In FIG. 5A and FIG. 5B, communication between the manager 101 and the agent 102 and between the agent 102 and the devices 104 and 105 uses HTTP. The HTTPS may be used for both communications. Alternatively, HTTPS may be used for the communication between the manager 101 and the agent 102 and HTTP may be used for the communication between the agent 102 and the device 104. In this case, protocol portions of the URL 502 and the URL 504 are both “http”; however, the URL generated by the cache control unit 312 of the agent 102 in step S402 of FIG. 4 is the URL 502 with the protocol portion replaced with “https”. Additionally, another protocol (e.g., File Transfer Protocol (FTP)) may be used for communication.

In FIG. 5A and FIG. 5B, the agent 102 performs the processing of replacing the URL for the devices 104 and 105 to obtain an application. This replacement processing may be performed by the manager 101. In this case, first, the manager 101 obtains the host address of the agent 102 associated with the device 104. Then, the URL 502 for obtaining the data of the application from the manager 101 is replaced with the URL 504 for obtaining the cache of the agent 102. Even in such a case, in a case where the agent 102 and the manager 101 operate on the same host, the above-described replacement is not performed. The manager 101 transmits the URL 504 to the agent 102 in step S501 of FIG. 5A and in step S521 of FIG. 5B. In this case, the agent 102 does not replace the URL and transmits the URL to the devices 104 and 105 in step S503 of FIG. 5A and in step S522 of FIG. 5B. Then, in a case where the corresponding software is not cached when the agent 102 receives a software obtainment request from the device based on the URL 504, the agent 102 converts the URL 504 to the URL 502 of the manager 101. Then, the agent 102 uses the URL 502 to obtain the software. The subsequent processing is similar to that described above, and thus description of the processing is omitted.

The agent 102 may perform processing of periodically maintaining cache management information of the table illustrated in Table 1. For example, entries for which a certain amount of time has passed since being registered in the table and data thereof may be deleted. Specifically, for entries that are greater than or equal to a designated value (e.g., 24 hours) between the last access date and time and the current date and time, processing of deleting a file in the agent 102 indicated by the file path of those entries and deleting the corresponding entries in Table 1 may be performed.

As describe above, in the present embodiment, software cache function is arranged for the agent. This makes it possible to, when an application or firmware obtainment is performed, avoid concentration of accesses to the manager and lighten the burden on the manager.

[Processing Sequence]

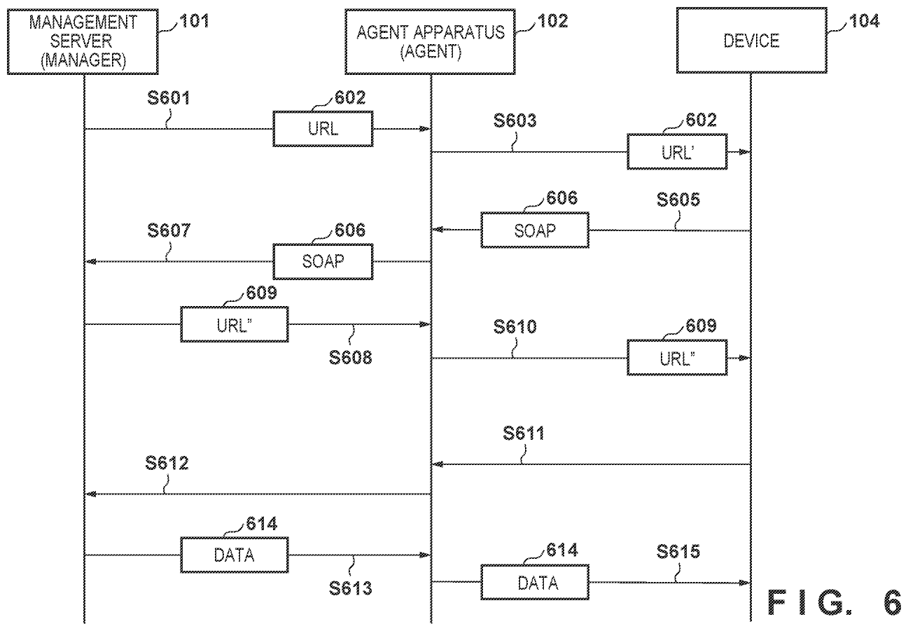

Next, FIG. 6 is a sequence diagram illustrating a flow of processing in a case where the manager 101 instructs the device 104 assigned to the agent 102 to update firmware. Here, assume that the agent 102 has not cached the data necessary for updating firmware of the device 104. Also, assume that the IP addresses of the manager 101 and the agent 102 are “192.168.10.100” and “192.168.10.200”, respectively.

First, an overview of a series of processing will be described. The device queries the agent for necessary firmware. The agent transfers that query to the manager and transfers a response from the manager to the device. By that transfer of a response, the manager instructs the device to obtain a firmware update file from the agent. Then, in accordance with that instruction, the device obtains a firmware update file from the agent. At that time, the agent, in a case where a firmware update file is in a cache, transmits the update file in the cache to the device. Meanwhile, in a case where there is no update file in the cache, the agent obtains an update file from the manager, saves it in the cache, and then transmits the update file to the device.

In FIG. 6, the manager 101 transmits to the HTTP/HTTPS server 311 of the agent 102 a request that includes an instruction to update firmware to the device 104 (step S601). The instruction here includes a URL 602 (e.g., “http://192.168.10.100:8080/ws/basic/”) of the SOAP HTTP/HTTPS server 306 in the manager 101 for the device 104 to start a firmware update.

The HTTP/HTTPS server 311 of the agent 102 receives that request and calls the task execution unit 310 in order to execute the requested processing. The task execution unit 310 replaces the URL 602 included in that request with a URL′ 604 (e.g., “http://192.168.10.200:8080/ws/basic/”) of the HTTP/HTTPS reverse proxy 313 of the agent 102 (in the agent) and then transmits a firmware update request to the device 104 (step S603).

The device 104 receives that request and then transmits in relation to the URL′ 604 included in the request an HTTP/HTTPS request that includes a SOAP message 606, which includes product information of the device itself and version information of firmware (step S605).

The HTTP/HTTPS reverse proxy 313 of the agent 102, when it receives this request, transmits the SOAP message 606 in the request to a URL (e.g., “https://192.168.10.100:8443/ws/secure/”) of the SOAP HTTP/HTTPS server 306 of the manager 101 (step S607) as is. Here, the request from the device 104 is HTTP; however, an HTTPS protocol is used in order to improve confidentiality in the communication between the agent and the manager.

The SOAP HTTP/HTTPS server 306 in the manager 101 receives that request and invokes firmware update processing of the firmware management unit 305.

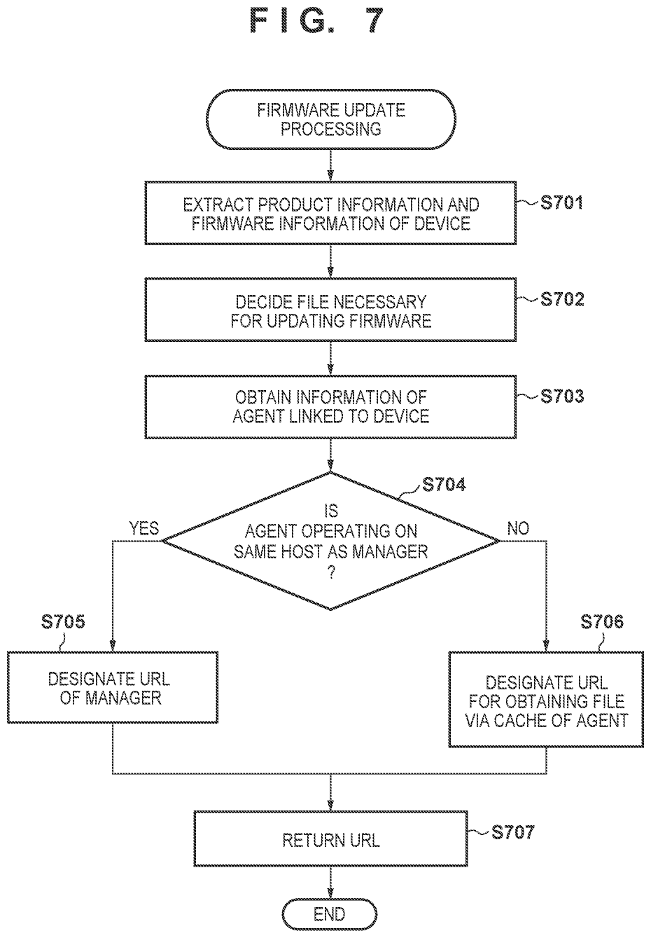

Here, FIG. 7 is a flowchart illustrating a flow of firmware update processing that the firmware management unit 305 in the manager 101 executes upon receiving the processing in step S607 of FIG. 6.

First, in step S701, the firmware management unit 305 fetches product information of the device and version information of firmware of the device 104 included in the SOAP message.

In step S702, the firmware management unit 305 decides the file necessary for updating the firmware of the device 104 based on the information fetched in step S701.

Next, in step S703, the firmware management unit 305 obtains information of the agent 102 associated with the device 104.

In step S704, the firmware management unit 305 confirms whether or not the agent 102 is operating on same host as the manager 101. As a result of confirmation, in a case where the agent 102 and the manager 101 are operating on the same host, the processing advances to step S705.

In step S705, the firmware management unit 305 designates a URL for obtaining a file from the URL of the HTTP/HTTPS server 304 of the manager 101. The URL is, for example, “https://192.168.10.100/public/firmware/ca071592-3a64-4c88-9013-cd28a73a7901”.

Meanwhile, in a case where the agent 102 and the manager 101 are operating on different hosts, the processing advances to step S706.

In step S706, the firmware management unit 305 designates a URL for obtaining a file via the cache of the agent 102. The URL here is a URL of a reverse proxy of the agent 102 and is, for example, “https://192.168.10.200/cache/firmware/ca071592-3a64-4c88-9013-cd28a73a7901”.

Lastly, in step S707, the firmware management unit 305 returns the URL decided in step S705 or S706 to a caller of processing (device).

As described above, in a case where the agent 102 and the manager 101 are operating on the same host, the cache function of the agent 102 is not used at a time of obtaining firmware data and in a case where they are operating on different hosts, the cache function is used.

Note that in the present embodiment, description is given assuming that the agent is operating on the same host as the manager. In other words, it is Yes in step S704, the processing advances to step S705, and in step S707, the URL of the manager is returned.

The series of processing in FIG. 7 is thus ended, and the processing returns to FIG. 6. At this time, in accordance with the processing illustrated in FIG. 7, a URL″ 609 for obtaining data in order for the device 104 to update the firmware is designated. The URL″ 609 is update URL information and is, for example, “https://192.168.10.200/cache/firmware/ca071592-3a64-4c88-9013-cd28a73a7901”.

Then, the manager 101 returns this URL″ 609 as a response to the request from the HTTP/HTTPS reverse proxy 313 of the agent 102 in step S607 (step S608).

The HTTP/HTTPS reverse proxy 313 of the agent 102 receives this response. Then, the HTTP/HTTPS reverse proxy 313 returns this response, which includes the URL″ 609 for firmware obtainment, to the device 104 as is (step S610).

The device 104, when it receives this response, transmits an HTTP/HTTPS request to the URL″ 609 included in the response received in step S610 in order to obtain data necessary for updating firmware (step S611).

The HTTP/HTTPS server 311 of the agent 102 that received this HTTP/HTTPS request invokes the data obtainment processing described in FIG. 4. The subsequent processing pertaining to this sequence (the processing in steps S612, S613, and S615) is the same as the processing described in steps S506 to S510 of FIG. 5A; accordingly, description will be omitted.

Lastly, the device 104 that received the response in step S615 executes firmware update processing of the device itself using data 614 included in the response.

It goes without saying that here, in a case where data designated by the cache control unit 312 of the agent 102 is cached, the processing described in steps S523 to S524 of FIG. 5B is executed and data obtainment related to the manager 101 is not executed. A series of sequence of FIG. 6 thus ends.

As described above, according to the sequence of FIG. 6, a function for transferring a query request to a manager is arranged in an agent and an address for the transferring function of the agent is designated to the device as a query destination. This makes it possible to limit communication between a device and the manager, whereby security can be improved.

[Modification]

There are cases where the device 104 is set so as not to permit, at the time of HTTPS communication, communication with an HTTPS server that has an untrusted certificate. Here, assume that the HTTPS server of the manager 101 is operating with an officially issued certificate but the HTTPS server of the agent 102 or the agent 103 is operating with a self-signed certificate as the main purpose is to conceal communication with the manager 101. In this case, if the self-signed certificate of the agent is not registered to the device 104, the device 104 will reject the HTTPS connection to the agent 102 from the device 104.

In a case where in such a situation, designation is performed to use the device 104 and HTTPS, the management system operates so as not to use the cache function or the HTTP/HTTPS reverse proxy 313 of the agent.

More specifically, URL replacement is not implemented in the following processing that has been described in the above embodiments.

1. step S503 of FIG. 5A

2. step S522 of FIG. 5B

3. step S603 of FIG. 6

Furthermore, the determination processing in step S704 of FIG. 7 is replaced with “IS COMMUNICATION FROM DEVICE HTTPS AND IS AGENT OPERATING ON SAME HOST AS MANAGER?”

Note that in the present embodiment, description was given using an example of a device firmware update; however, it goes without saying that the present invention can be widely applied for the device to obtain an update file for a software update.

By virtue of the present invention, it becomes possible to limit direct communication between a manager that manages software and a device. Accordingly, it is possible to improve security.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-136379, filed Aug. 12, 2020, which is hereby incorporated by reference herein in its entirety.

What is claimed is:

1. A management system comprising: a manager apparatus configured to manage a device; and an information processing apparatus configured to function as an agent that performs communication via a network with the device based on an instruction of the manager apparatus,
wherein the manager apparatus transmits an instruction of a device operation to the agent,
wherein the information processing apparatus, as a function of the agent, in a case where an update of software of a device has been instructed as a device operation from the manager apparatus, transmits to that device an update request, which includes URL information that indicates a reverse proxy which operates in the information processing apparatus, and
wherein by the device performing transmission of data in response to the update request to the URL information that indicates the reverse proxy, that data is transferred to the manager apparatus via the information processing apparatus.

2. The management system according to claim 1, wherein the manager apparatus, in a case where the data has been transferred via the information processing apparatus, transmits to the device via the reverse proxy a response that includes update URL information for obtaining an update file of the software.

3. The management system according to claim 2, wherein the manager apparatus, in a case where it is determined that the agent is not operating on the same host as the manager apparatus, designates, as the update URL information, URL information of the agent for obtaining the update file via a cache of the agent.

4. The management system according to claim 2, wherein the manager apparatus, in a case where it is determined that the agent is operating on the same host as the manager apparatus, designates, as the update URL information, URL information for accessing the update file in the manager apparatus.

5. The management system according to claim 1, wherein the manager apparatus decides an update file of the software based on device information included in the transferred data.

6. The management system according to claim 5, wherein the device information includes product information of the device and version information of the software.

7. A method of controlling management system comprising: a manager apparatus configured to manage a device; and an information processing apparatus configured to function as an agent that performs communication via a network with the device based on an instruction of the manager apparatus, the method comprising:
the manager apparatus transmitting an instruction of a device operation to the agent; and
the information processing apparatus, as a function of the agent, in a case where an update of software of a device has been instructed as a device operation from the manager apparatus, transmitting to that device an update request, which includes URL information that indicates a reverse proxy which operates in the information processing apparatus,
wherein by the device performing transmission of data in response to the update request to the URL information that indicates the reverse proxy, that data is transferred to the manager apparatus via the information processing apparatus.

8. The method of controlling according to claim 7, wherein the manager apparatus, in a case where the data has been transferred via the information processing apparatus, transmits to the device via the reverse proxy a response that includes update URL information for obtaining an update file of the software.

9. The method of controlling according to claim 8, wherein the manager apparatus, in a case where it is determined that the agent is not operating on the same host as the manager apparatus, designates, as the update URL information, URL information of the agent for obtaining the update file via a cache of the agent.

10. The method of controlling according to claim 8, wherein the manager apparatus, in a case where it is determined that the agent is operating on the same host as the manager apparatus, designates, as the update URL information, URL information for accessing the update file in the manager apparatus.

11. The method of controlling according to claim 7, wherein the manager apparatus decides an update file of the software based on device information included in the transferred data.

12. The method of controlling according to claim 11, wherein the device information includes product information of the device and version information of the software.
